(19) United States
(12) Patent Application Publication
(10) Pub. No.: US 2011/0256281 A1
(43) Pub. Date: Oct. 20, 2011

(54) Cheese fabricating machine and method

(76) Inventor: Charles Johnson, Westfield, WI (US)

(21) Appl. No.: 12/799,293

(22) Filed: Apr. 20, 2010

(51) Int. Cl. A01J 25/12; A01J 27/02

(52) U.S. Cl. 426/289; 425/377; 426/516

(57) ABSTRACT

Apparatus and methods for fabricating semi-solid food product such as cheese into bite-size or larger pieces by placing the product into a receptacle and pushing the product through a two-dimensional matrix of closely-spaced die apertures without disrupting the overall longitudinal conformation of the food product other than cutting the pieces for length. Substantial portions of the product emerge from the process having maintained fabrication conformation and longitudinal alignment with die apertures before, during, and after passing through the die, relative to where those portions were when received in the receptacle. The receptacle and die are cooperatively configured and aligned that, when product is introduced into the receptacle and pushed through the die, substantial portions of the product emerging from the die have remained in longitudinal alignment with respective die apertures before, during, and after passing through those apertures, relative to where those portions were when received in the receptacle.

### BACKGROUND

This invention pertains to methods and apparatus for fabricating semi-solid food products such as cheese. More particularly, the invention pertains to methods of forming bite-size chunks of such food product from either a previously-formed larger single block of such food product or from a mass of the food product of any size which can be fed into a receptacle in the apparatus. Where a single block of the food product is used as the raw material fed to the apparatus, scraps or other trim or discard pieces, of any size, can be added to the receptacle along with the single block, as additional feed material.

Cheese is generally manufactured in relatively large blocks and cut for sale into smaller blocks or chunks having shapes and sizes selected according to consumer preference. For example, cheese is commonly sold in cylindrical or rectangular shapes, or in sliced form. Cutting a parent cheese block to make smaller retail-size portions is commonly done with cutting wires which are stretched tight between a pair of wire mounts. Cutting “surfaces” such as a knife are less desirable because the cheese drags on the side of the knife, thus adding greatly to the amount of force required to perform the cut. Thus knife cutting is not commonly practiced in commercial conversion of cheese parent blocks into consumer-size blocks and chunks.

However, cutting with a wire does not separate the cut pieces from each other, and the cheese tends to close on the cut surfaces as soon as the wire has passed, which leads to the cut surfaces bonding back together. As a result, while the cheese has been cut, the cut pieces are not readily separated from each other.

The industry thus uses substantial manual labor to separate the cut pieces of cheese from each other.

Thus, an ongoing goal in the cheese industry is to find commercially cost-effective ways to cut the cheese into pieces of desired size in combination with cost-effective ways of separating the cut pieces from each other.

Single-serving size food products, and bite-size food products are growing in popularity, whereby it would be desirable, in addition to providing cost-effective ways to cut and separate chunks of cheese, to provide ways to fabricate such products in bite-size pieces.

While it is known to apply various food-grade powders to the cheese surface to prevent cheese pieces from sticking together, such powder can only be effectively applied where the pieces of cheese are first separated from each other so as to expose the surfaces to be coated. It is this separating which is currently done by manual labor.

It is known to use an auger-based feed apparatus to mix and feed cheese to a die, using a die which is sized to fabricate shreds of the cheese, such shreds as are used on pizza products, and wherein the shreds exiting the die are spaced transversely from each other by substantial distances. In such feed operation, the cheese is substantially mixed in the auger-based feed process whereby the original fabrication conformation of what was the parent cheese block is severely, typically entirely, disrupted during the mixing and feeding process. In addition, substantial portions of the cheese necessarily traverse the feed chamber transversely in order to enter the substantially spaced shred-producing apertures.

Disruption of the cheese conformation, and the associated working of the cheese can cause a number of changes in the resultant cheese product. The more the cheese is worked, the more the cheese conformation is disrupted, and the greater the potential for negative side effects. For example, the working of the cheese can disrupt the texture of the cheese such that the re-worked cheese has a tougher texture. Also working of the cheese can raise the temperature of the cheese which can affect the chemical composition of the cheese. Changes in chemical composition of the cheese can affect the flavor of the resultant cheese product, and may also have other affects. In addition, the shred-extrusion process leaves the shreds with relatively rough surfaces.

And since cheese-making is an art as much as a science, changes in the processing steps used in making and fabricating the cheese product can introduce unexpected side effects. Accordingly, it is desirable, when fabricating cheese into consumer-ready products, to limit the number of processing steps, as well as to limit the amount of physical working, including the degree of physical disruption of the structure, to which the cheese is exposed.

Finally, consumer preference indicates that any process which fabricates a bite-size product is expected to produce a product which looks like a conventionally-cut block of cheese. For example, the product piece should be well consolidated such that it does not readily disintegrate when picked up. Further, the surfaces of the piece should be smooth, preferably shiny, as is the case in a wire-cut block of cheese.

It is known to cut a large e.g. parent block of cheese (e.g. about 640 pounds) into relatively smaller strips, e.g. 3 inches high by 3 inches wide, by passing the parent block of cheese through a vertically-oriented grid of e.g. vertically and horizontally oriented cutting wires, thus to create a rectangular-shaped array of elongate, horizontally-oriented cheese blocks. This array of elongate blocks is then moved in a perpendicular direction (left or right) without reorienting the block/array, and passed through a second vertically oriented grid of e.g. vertically oriented cutting wires, which cuts the elongate blocks into shorter, smaller blocks of e.g. 1-5 pounds each.

Cheese is, of course, a plastic material which preferentially resiliently re-forms to its former shape after passing around a cutting wire. And the cheese is typically tacky, whereby the cut surfaces of the cheese readily re-adhere to each other, sometimes with at least a temporary memory of the cut interface.

Such cutting process can, in some instances, be made successful by impacting each row of cheese as it proceeds off the end of a supporting table at the fabrication location. For example, a downwardly-deployed bar can separate a row of the cut cheese blocks from the rest of the array/block, such that the separated smaller blocks fall onto a take-away conveyor. In any event, where cheese blocks are cut by wires, each of the wire-cut surfaces is planar because the wire needs to be straight and tight in order to make the cut.

It is also believed to be known to pass a block of cheese through a vertical grid where much smaller cross-section elongate “strands” of cheese are formed, and then to cut cubes of cheese off the end of the block by manually manipulating, downwardly, a transversely oriented cutting wire, and manually removing the cut pieces from the end of the cube.

It is further known to pour melted cheese into molds to form the cheese into desired shapes which may have straight or curved sides and to then cool the melted cheese back to e.g. room temperature, or cooler, to return it to its normally semi-solid state. However, the melting changes both the texture and the flavor of the resulting cheese.

While such processes can make desired-size pieces of cheese, the wire-cutting method requires a certain amount of manual separation of the resultant pieces, and the melting method causes chemical “working” of the cheese, which changes the nature of the cheese product.

Thus it is desirable to provide cost-effective methods of making bite-size pieces of cheese which meet consumer-preference criteria, while limiting the amount of working to which the cheese is exposed.

It is further desirable to provide machines which can make bite-size pieces of cheese while limiting the amount of working to which the cheese is exposed.

It is also desirable to provide methods of fabricating cheese through a die where elements of the cheese as fabricated remain generally in longitudinal alignment with the respective elements of the cheese prior to the fabrication, whereby the amount of working to which the cheese is exposed is limited.

It is still further desirable to provide apparatus and methods wherein the food product so produced retains the fabrication conformation of the food material from which it was made.

It is yet further desirable to provide apparatus and methods which can produce bite-size pieces of semi-solid food products wherein the apparatus and methods limit the ability of the pieces to agglomerate together.

The invention creates desired-size, e.g. bite-size, pieces of cheese or other semi-soft food product, using a mechanical process which essentially eliminates manual steps other than to load the feed portion of cheese into the fabrication apparatus. Such loading may, of course, be automated as desired.

### SUMMARY

This invention provides apparatus and methods for placing a semi-solid block of cheese in a receptacle, and fabricating/re-forming the block of cheese into bite-size or larger pieces by feeding the cheese, with a pushing ram, to a forming die and passing the cheese through apertures in the die, both without disrupting the overall longitudinal conformation of the cheese block other than cutting the pieces for length. Thus, substantial portions of the cheese emerge from the process having maintained longitudinal alignment with the die apertures, before, during, and after passing through apertures in the die, relative to where those portions were when received in the receptacle.

In a first family of embodiments, the invention comprehends apparatus for converting semi-solid food product into a plurality of relatively smaller size product chunks. The converting apparatus comprises a receptacle, having a feed portion associated with a feed end of the receptacle, an exit portion associated with an exit end of the receptacle, and a length between the feed end and the exit end. An interior space is disposed between the feed end and the exit end, the interior space having a cross-section defined along the length of the receptacle. A feed opening is disposed in the feed portion whereby food product to be converted can be loaded into the interior space of the receptacle. A forming die is connected to the exit end of the receptacle. The forming die has a feed side facing toward the receptacle and an exit side facing away from the receptacle. The forming die comprises a two-dimensional matrix of apertures extending through the forming die between the feed side and the exit side. The two-dimensional matrix of apertures in the forming die extends across substantially the entirety of the cross-section of the interior space defined at the exit end of the receptacle, each aperture in the two-dimensional matrix being spaced from another of the apertures in the matrix by no more than 0.3 inch. A pusher is adapted to engage a mass of semi-solid food product, with the pusher being disposed between the feed end of the receptacle and any such mass of semi-solid food product in the receptacle, and is adapted to engage a rear of such mass, and to push such mass in a direction along the length of the receptacle and through the forming die. The receptacle and the forming die are so cooperatively configured and aligned relative to each other that, when a such mass of semi-solid food product is introduced into the receptacle and pushed through the die by engaging the pusher against the rear of such mass and pushing, thus converting the mass of semi-solid food product into a plurality of emerging strands of such semi-solid food product, such emerging strands having strand lengths, and cross-sections substantially smaller than the cross-section of the exit portion of the receptacle, substantial portions of the semi-solid food product emerge from the die having maintained longitudinal alignment with the respective apertures before, during, and after passing through the respective apertures, relative to where those portions were when received in the receptacle. The apparatus further comprises a cutter which periodically cuts such emerging strands transverse to the lengths of such strands, thereby to convert such emerging strands into multiple individual and separate pieces of such food product.

In some embodiments, the pusher is adapted to engage such mass of food product, as a semi-solid feed block, only at a trailing end of that feed block, where the feed block has a fabrication conformation and can generally hold cross-section stability of that fabrication conformation while being pushed through the die, and the receptacle and the forming die are so cooperatively configured and aligned relative to each other that, when a such feed block of semi-solid food product, having a cross-section generally conforming to the cross-section of the exit portion of the receptacle, is placed in the receptacle and forced through the die by engaging the pusher against the trailing end of the feed block and pushing, thus converting the feed block of semi-solid food product into such plurality of emerging strands of semi-solid food product, the semi-solid food product strands emerging from the die generally retain the fabrication conformation of the feed block.

In some embodiments, the apparatus further comprises a separator which separates newly-agglomerated ones of such pieces from each other.

In some embodiments, the separator and the cutter collectively comprise (i) a wheel having an outer perimeter edge and a plurality of cutting wires extending across the wheel transverse to the outer perimeter edge, (ii) an enclosure substantially enclosing a space extending lengthwise away from the exit side of the die and enclosing the wheel, (iii) a powder dispenser adapted to feed powder into the enclosed space, (iv) an exit opening at a bottom of the enclosure, sized and configured to accommodate the emergent and cut pieces of product exiting the enclosure, and (v) breaker bars on the wheel, the breaker bars rotating with the wheel, such that the breaker bars pass across the exit opening as the wheel rotates, whereby as the wheel rotates and the cutting wires engage the emerging strands, and cut pieces of product from the emerging strands, the pieces of product are coated by powder dispensed from the powder dispenser, and the coated pieces of product fall toward the exit opening, and are engaged by the breaker bars passing across the exit opening, such engagement between the moving breaker bars and the pieces of product tending to separate the pieces of product which have agglomerated with each other.

In some embodiments, walls of the apertures extend between the feed side and the exit side at angles of no more than 10 degrees relative to the direction in which the mass of food product is pushed through the die.

In some embodiments, walls of the apertures extend from the feed side to the exit side in a generally common direction.

In some embodiments, the die has a thickness, between the feed side and the exit side, of at least about 0.25 inch.

In some embodiments, walls of the apertures, which face inwardly into the aperture openings, having surface finishes which, when semi-soft cheese product is pushed through the die, tend to create smooth surfaces on the cheese product strands which emerge from the apertures at the exit side of the die, and wherein thickness of the die between the feed side and the exit side is great enough that the die forces elongation of the emerging cheese strands such that the smooth surfaces created by the walls of the apertures are generally retained in the emergent cheese strands, and adjacent ones of the emergent strands of cheese remain spaced from each other upon exiting the die.

In some embodiments, each aperture is spaced from each of the other apertures, at locus of closest proximity, by at least 0.03 inch, and spaced from adjacent ones of the other apertures, at locus of closest proximity, by no more than 0.2 inch.

In some embodiments, the pusher has a pushing surface which extends across substantially the entire cross-section of the interior space of the receptacle between the feed opening and the exit end of the receptacle.

In a second family of embodiments, the invention comprehends apparatus for converting semi-solid food product into a plurality of relatively smaller size product chunks. The converting apparatus comprises a receptacle, having a feed portion associated with a feed end of the receptacle, an exit portion associated with an exit end of the receptacle, a length between the feed end and the exit end, an interior space between the feed end and the exit end, the interior space having a cross-section defined along the length of the receptacle, and a feed opening in the feed portion whereby food product to be converted can be loaded into the interior space of the receptacle. A forming die is connected to the exit end of the receptacle. The forming die has a feed side facing toward the receptacle and an exit side facing away from the receptacle. The forming die comprises a two-dimensional matrix of apertures extending through the forming die between the feed side and the exit side. A pusher is adapted to engage a mass of semi-solid food product, with the pusher being disposed between the feed end of the receptacle and any such mass of semi-solid food product, and adapted to engage a rear of that mass, and to push that mass along the length of the receptacle and through the forming die. The apparatus further comprises a cutter, comprising a wheel having an outer perimeter edge, and a plurality of cutting wires extending across the wheel transverse to the outer perimeter edge, the wheel being mounted on a shaft for rotation, with the shaft as the axis of such rotation. The shaft extends in a direction generally aligned with the length of the receptacle, and off-set transversely from the receptacle, the wheel being aligned with, and positioned relative to, the forming die such that rotation of the wheel causes the cutting wires to pass across the exit side of the forming die, in close proximity to the forming die such that the cutting wires cut the emerging strands, emerging from the forming die, substantially at the exit side of the forming die, cutting the emerging strands transverse to lengths of the emerging strands, thereby to convert the emerging strands into multiple individual and separate pieces of food product.

In some embodiments, the apparatus further comprises a wheel, the wheel comprising a first rotating body, a second rotating body being spaced from the wheel, and positioned toward the receptacle relative to the wheel, the breaker bars extending between the wheel and the second rotating body.

In some embodiments, the first rotating body extends from a first outer perimeter to a central axis of rotation of the first rotating body, at least portions of the first rotating body being projectable onto the second rotating body, and the breaker bars are mounted to both of the first and second rotating bodies, and extend across the space between the first and second rotating bodies.

In a third family of embodiments, the invention comprehends a method of making cheese chunks, individual and separated from each other. The method comprises introducing a mass of cheese through a feed opening into an interior space in a receptacle having a feed portion associated with a feed end of the receptacle, and an exit portion associated with an exit end of the receptacle, the interior space being disposed between the feed end and the exit end and having a cross-section defined along the length of the receptacle, the feed opening providing product feed access to the interior space. The method further comprises engaging a pusher against the mass of cheese, with the pusher being disposed between the feed end of the receptacle and the mass of cheese, and pushing the mass of cheese in a direction along the length of the receptacle and through a forming die and thereby concurrently forming a plurality of cheese strands emerging from the forming die, the forming die comprising a two-dimensional matrix of apertures which define openings extending through the forming die, the two-dimensional matrix of apertures in the forming die extending across substantially the entirety of a cross-section of the interior space, defined at the exit end of the receptacle, such that substantial portions of the semi-solid cheese strands emerging from the forming die generally have maintained longitudinal alignment with the respective apertures before, during, and after passing through the respective apertures, relative to where those portions were when received in the receptacle. The method still further comprises periodically cutting the emerging cheese strands transverse to the lengths of such strands, thereby to convert such emerging strands into multiple individual and separate pieces of such cheese; and allowing the cut pieces to fall away from the forming die.

In some embodiments, the loading of the mass of cheese comprises loading a single block of cheese into the receptacle, and wherein a cross-section of the single block of cheese corresponds, with only processing clearance, with the cross-section of the interior space in the exit portion of the receptacle.

In some embodiments, the method further comprises allowing the cut cheese pieces to fall away from the die along a generally-defined path, coating the cut cheese pieces with anti-caking powder, and interrupting the fall of the pieces by engaging the cut pieces with breaker bars, in the known path, thereby to separate ones of such cheese pieces which have agglomerated with each other.

In some embodiments, the emerging strands produced by the method, emerging from the die apertures, have cross-sections of at least 0.06 square inch, optionally at least 0.14 square inch.

### BRIEF DESCRIPTION OF THE DRAWINGS

FIG. 1 shows a pictorial view, with parts cut away, of cheese apparatus of the invention, viewed from the feed end of the apparatus.

FIG. 2 shows a pictorial view, with parts cut away, of cheese apparatus of the invention, viewed from the exit end of the apparatus.

FIG. 3 shows a pictorial view of a first die used in the fabrication apparatus of FIGS. 1-2.

FIG. 4 shows an elevation view of a second die as in FIG. 3, wherein the second die illustrates three different aperture configurations.

FIG. 5 shows a representative side elevation view, with parts cut away, of the cheese apparatus shown in FIGS. 1 and 2, and representatively showing the powder dispenser and a take-away conveyor.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

The basic concept of the invention is to replace a conventional vertically-oriented grid of cutting wires with a receptacle, and a similarly-oriented die having multiple perforations through which the cheese is to be pressed, while maintaining the die apertures in such close proximity to each other that a substantial portion of the cheese, e.g. greater than 50 percent by volume, maintains longitudinal alignment with the respective apertures, before, during, and after passing through the respective apertures.

A first feature of the die is that the die must have sufficient thickness, between the feed side of the die and the exit side of the die, that the die can form a smooth surface to the sides of the cheese pieces being formed, and can hold that smooth surface in the re-formed shape of the cheese pieces whereby the cheese is forced to elongate, sufficient that when the cheese is released at the end of the die, the cheese pieces do not return to the original cross-section of the feed block of cheese and, thus do not touch each other, whereby they, can be readily separated from each other without side-to-side sticking together of adjacent pieces.

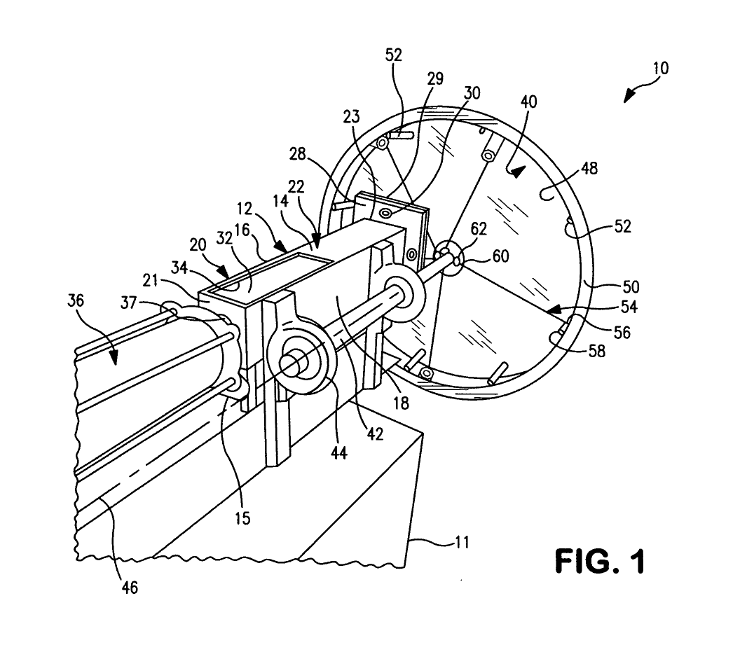

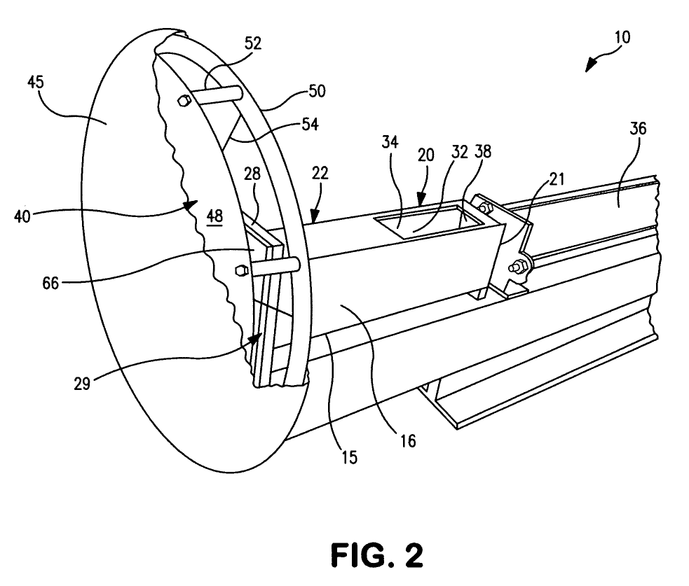

FIGS. 1 and 2 illustrate the basic principles of the mechanics of a cheese press apparatus 10 of the invention, mounted to an underlying frame 11 which can support the apparatus from a floor or other underlying support. Press 10 has an elongate receptacle 12. Receptacle 12 has a top 14, a bottom 15, a left side 16, a right side 18, a feed portion 20 including a feed end 21, an exit portion 22 including an exit end 23, and a length “L” between the feed end and the exit end. A flange 28 extends outwardly from the top, the bottom, the left side, and the right side of the receptacle at the exit end. A die 29 is removably mounted to the flange with a series of bolts 30, thus covering the otherwise-open exit end of the receptacle. In the embodiment shown, an interior space 32 inside the receptacle has a generally square cross-section transverse to the length.

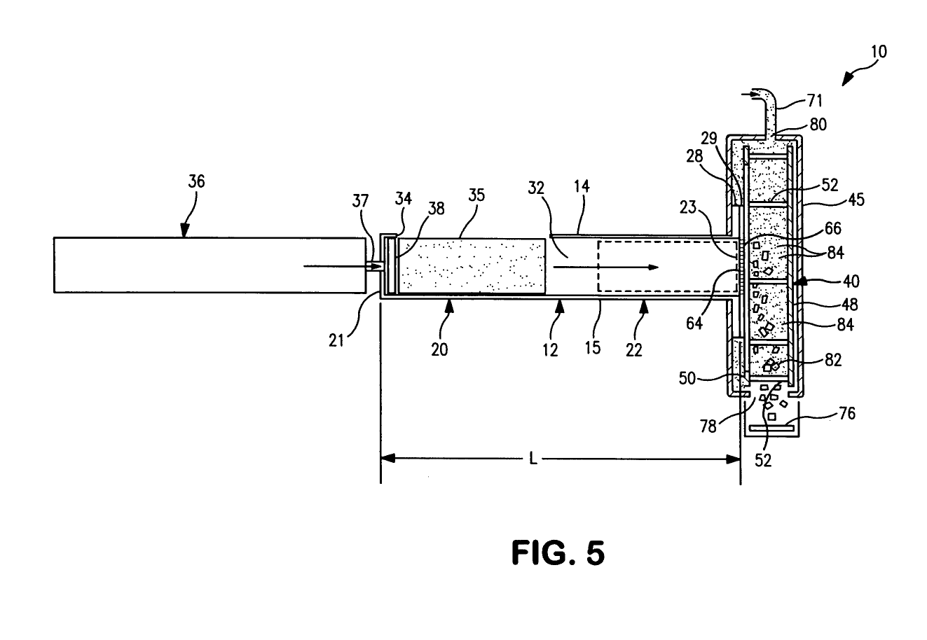

In the feed portion of the receptacle, the top is cut away between the left and right sides of the receptacle, leaving a feed opening 34 which can receive a block cheese 35 (FIG. 5) which generally fills the full cross-section, top to bottom, and left to right, of the interior space in the receptacle, allowing sufficient clearance that the cheese block can be placed in the receptacle without undue lodging of the sides of the cheese block against the sides of the receptacle. Typical target clearance between the receptacle walls and the block of cheese is about 1/32 inch to about 1/16 inch on each of the left and right sides of the receptacle, and at the top, of the receptacle.

A hydraulic cylinder 36 is positioned to the rear of the feed end of the receptacle. The ram 37 from the cylinder extends through the feed end of the receptacle and into the interior space in the receptacle. The end of the ram terminates in a pusher plate 38 which generally fills the longitudinally-extending cross-section of the receptacle, again allowing sufficient clearance for movement of the ram along the length of the receptacle without the pusher place lodging against the interior wall surfaces of the receptacle.

A wheel 40 is mounted to a shaft 42. Shaft 42 is mounted to frame 11 by bearings 44 so as to be oriented to rotate about a longitudinal axis 46 which is perpendicular to the exit side of die 29 and generally aligned with length “L” of receptacle 12, whereby wheel 40 is generally oriented parallel to the exit side of the die.

As illustrated, wheel 40 includes a first rotating body, shown as a disc 48, mounted to shaft 42, and a second rotating body, shown as a ring 50, spaced from the first rotating body and positioned toward the receptacle relative to the first rotating body.

A plurality of breaker bars 52 are spaced about the outer perimeter of the disc 48 and extend from locations proximate disc 48 to locations proximate ring 50. Typically, breaker bars 52 are mounted, optionally indirectly, to both of the first and second rotating bodies.

The spacing between the first and second rotating bodies is greater than the lengths of the pieces of cheese which are to be cut from the emerging strands of cheese which will be exiting die 29. Where the breaker bars are mounted to both the first rotating body and the second rotating body, changes in spacing between the first and second rotating bodies can be affected by mounting the rotating bodies closer to each other or farther away from each other, on the breaker bars, or by replacing the breaker bars with shorter or longer breaker bars, which can accomplish the same break-up function.

While rotating bodies 48, 50 are shown having circular perimeters, those bodies can have any outline/perimeter/shape which accommodates connecting with, and supporting, the breaker bars 52 and/or using the breaker bars as spacers for mounting the first and second rotating bodies to each other.

A plurality of cutting wires 54 are mounted to wheel 40, spaced about the perimeter of the wheel. For each wire in the illustrated embodiment, a first wire end 56 is mounted to a first stud 58 which extends from the outer perimeter of disc 48, and a second wire end 60 is mounted to a second stud 62 which extends from disc 48 at approximately the center of the disc, whereby wires 64 rotate with disc 48. A suitable motor drive (not shown) rotates shaft 42 and thus wheel 40. Wires 54 are positioned relative to die 29 such that, as wheel 40 rotates, the wires pass in sequence across the surface of the exit side of die 29 closely adjacent the die surface, optionally touching the die surface. So the rotation of wheel 40 periodically brings each cutting wire 54 across the face of the die, thereby cutting through any length of emergent cheese strand which has emerged from the die since the last time a cutting wire rotated across the exit side of the die.

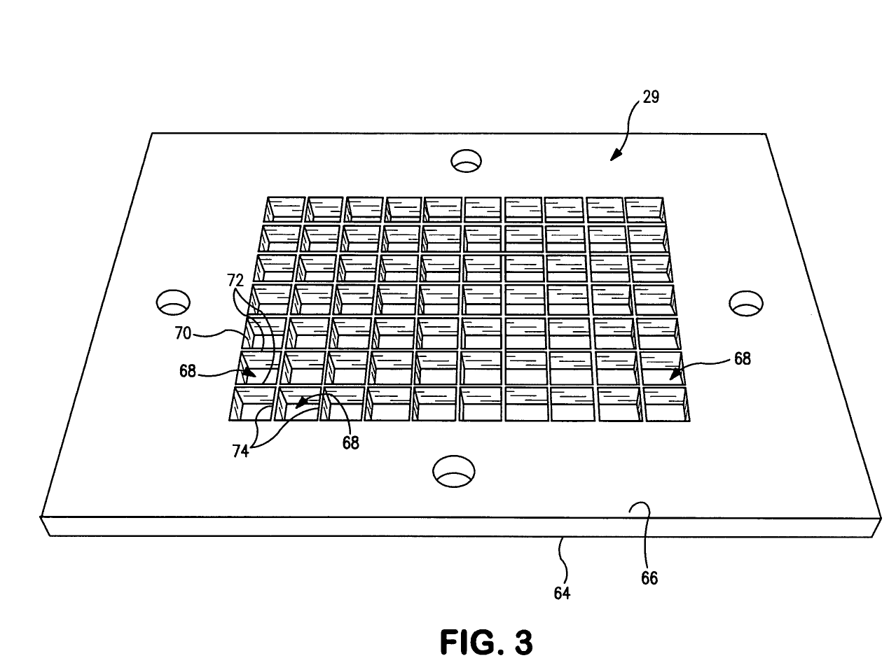

FIG. 3 illustrates a die which can be used to make small, rectangularly-shaped blocks of cheese according to the invention, for example pieces which are about 0.5 inch top-to-bottom and 0.5 inch side-to-side, thus about 0.25 square inch in cross-section. Referring to FIG. 3, the die has a feed side 64 which faces the receptacle flange and receives the cheese from the interior space inside the receptacle as the pusher 38 pushes the cheese through the die. Die 29 also has an exit side 66. A plurality of apertures 68 extend between feed side 64 and exit side 66. The thickness of the die, from the feed side to the exit side, and thus the approximate lengths of walls 70 in apertures 68, are about ⅛ inch to about ½ inch. A typical die thickness is about ¼ inch.

As the cheese is forced through the apertures in the die, the spacing between the apertures forces the cheese to elongate as the cheese traverses the die. In normal die operation, the thickness of the die, in combination with the spacing between apertures 68, causes the cheese to elongate as it passes through the die. This elongation is accompanied by a re-forming, reduction in the cross-section of that elongated section of the cheese. The greater the spacings between the walls of adjacent apertures, the greater the amount of elongation imposed on the cheese as it traverses die 29. As an emerging strand of “re-formed” cheese emerges from the die, the pressure which forces the cheese through the die dissipates, and the cheese inherently expands to a limited extent according to its dimensional “memory”, as a result of that pressure release.

Where the cheese has been sufficiently elongated in the die, e.g. by the spacing of the apertures in combination with the thickness of the die, the cross-section of the emergent strand after release of the pressure is less than what the cross-section of that same portion of the cheese was as it approached the die in the receptacle. Namely, the cross-section of the cheese strand, in an unpressurized, rest condition, has been essentially permanently “re-formed”. That reduced cross-section establishes small spaces between the emerging strands of cheese, such that the emerging strands, even though they expand to a limited extent, do not touch each other as they emerge from the die.

If the thickness of the die is less than about ⅛ inch between the feed side and the exit side of the die, the inherent expansion of the cheese at the exit side of the die may be so great as to return the strands to the full cross-section of that same portion of the cheese as it approached the die; or at least enough expansion that the sides of some or all of the strands touch each other shortly after exiting die 29. Such touching typically results in the strands sticking to each other where the strands touch. While, as described later herein, anti-caking powder is introduced into the process at the exit side of the die in order to attenuate sticking together of the cut pieces, where surfaces of the pieces touch each other shortly after exiting the die, typically those touching surfaces will not have received sufficient coating, before they touch, to prevent development of the sticking/adhesion as the touching takes place. And once the strands are stuck together, addition of more powder does not cause release of the stuck pieces from each other.

If the die thickness is greater than about ½ inch, the resistance/friction between aperture walls 70 and the cheese strand being formed may become unacceptably high such that an undesirable amount of force is required of hydraulic cylinder 36. The minimum and maximum thicknesses of the die can vary depending on the type and plasticity of the cheese being processed, and those skilled in the art can readily ascertain such properties and adjust the die thickness accordingly, even somewhat outside the recited range of about ⅛ inch to about ½ inch.

Referring to FIG. 3, each aperture 68 in the die is formed by four walls 70. For purposes of illustration, a representative aperture 68 is bounded on its top and bottom by horizontally-extending bars 72, and on its sides by vertically-extending bars 74.

Referring to bars 72 and 74, a given bar is at least 1/32 inch thick at the exit side 66 of the die. The side walls 70 of the respective bars, which face into apertures 68 and thus directly contact the cheese, are smooth such that the cheese passing through the respective aperture is plastically deformed by the friction between the cheese and the wall surface, and the smoothness of the wall surface is, in general, transferred onto the side surface of the cheese strand which is in the process of being formed.

The desired degree of smoothness on walls 70 can be achieved by forming apertures 68 using conventionally-known laser cutters. The required smoothness of aperture walls 70 varies according to the plasticity of the cheese whereby the identity of the cheese to be fabricated is an element of the routine analysis appropriate to the design of a particular die 29.

The thickness of the bar 72, 74, e.g. at least 1/32 inch thick, in combination with the thickness of the die, e.g. at least about ⅛ inch, forces the cheese to deform longitudinally, namely along the direction in which the cheese is being pushed, sufficient that the cheese in a given exiting strand does not readily return fully to its former transverse cross-section. The recited dimensional requirements of e.g. at least about 1/32 inch thick bar means that the cheese strands are at least about 1/32 inch apart as they emerge from the exit side of the die. At that at least about 1/32 inch spacing, the cheese strands are far enough apart, as reformed by the respective bars, that they do not touch each other, even after modestly expanding as the strands emerge from the die. And since they have been plastically elongated as they pass through the die, the re-formed strands do not return fully to their former transverse cross-section after they exit the die. Since the resultant rest cross-section, after exiting the die, is smaller than the cross-section of the same cheese elements before they passed through the die, the sides of the emergent strands do not touch each other, and thus do not stick to each other.

If the die is thicker than the maximum thickness allotted for a particular type of cheese, then the depths of the respective bars can be correspondingly reduced by removing material from the bars at the feed side of the die such that the depths of the bars do not exceed the appropriate maximum thickness.

The die, as illustrated in FIG. 3, shows walls 70 of the apertures as being aligned with the direction of pushing of the cheese through receptacle 12 and through die 29. It is acceptable, though not necessary, to have a small angle of e.g. up to 10 degrees, optionally up to about 5 degrees, to side walls 70, relative to the direction of pushing the cheese, such that the cross-section of the aperture decreases in progressing from the feed side of the die to the exit side of the die. Such angle can be useful in instances where the cheese has not yet been fully consolidated whereby the angles result in a taper in the die apertures. As the cheese progresses through the apertures, such taper assists in consolidating the cheese to a more compact cross-section as it emerges from the die.

To further ensure that the cheese pieces do not stick together after exiting the die, a cloud of finely dispersed powdered, food-grade, anti-caking agent is introduced at the top of the shielded area as illustrated at feed pipe 71. The anti-caking agent powder is fed into the shielded area at a rate which maintains a powder-laden environment within substantially the entirety of the area enclosed by shield 45, such that any cheese strands emerging from die 29 are quickly exposed to a powder-laden atmosphere, and thus become quickly coated with the powder. Such powder coating can include, in addition to the anti-caking agent, an anti-fungal agent which attenuates growth of fungal bodies. Food grade powdered cellulose is a well-known anti-caking agent used in cheese processing. Natamycin is a well-known anti-fungal agent available from Nelson Jameson Company, Marshfield, Wis. under the trade name Delvocid®. Delvocid® is believed to be a registered trademark of DSM Food Specialties Inc, Parsippany, N.J.

A powder product which provides a combination of cellulose and natamycin is also available from Nelson Jameson Company under the trade name Solka-Floc®. Solka-Floc® is believed to be a registered trademark of International Fiber Corporation, North Tonawanda, N.Y.

As the cheese strands emerge from the die, into the powder-laden atmosphere, the leading end, and the emerging sides of the cheese pick up coatings of the anti-caking material whereby those surfaces of the emerging strands lose a substantial portion of their tacky characteristic. The fresh cut trailing sides of the cut-off pieces are tacky as cut. As the cut pieces fall from the die, they impact on each other whereby some of the fresh-cut trailing surfaces of the pieces are susceptible to sticking to each other before they become coated with the powder, and some pieces may stick together to form limited-size agglomerates of such cut-off pieces. As the cut-off pieces (FIG. 5) fall in a cascade, they encounter rotating wheel 40 in the form of rotating disc 48, rotating ring 50, rotating cutting wires 54, and/or rotating breaker bars 52. Where an agglomerate has formed from some of those pieces, the impacts of the encounters with the moving disc, the moving ring, the moving wires, and especially the moving breaker bars 52, tend to break apart any such agglomerations or other collections of multiple pieces of the resultant cheese product, whereby only minimal if any manual manipulation is necessary to separate the resultant cheese pieces from each other. Further, any separations of such collections/agglomerations exposes the still-tacky surfaces, of the pieces just broken apart, to the powder-laden environment inside the area enclosed by shield 45 whereby those freshly-exposed surfaces, as well, become coated with the powder.

A take-away conveyor 76 is arranged below die 29, with appropriate shielding or channeling to capture the falling pieces of cheese and convey such product away from below the exit opening 78 in shield 45.

In order to ensure efficient deposition of the powder coating onto the cheese surfaces, shield 45 entirely encloses the space about wheel 40, with the only openings being the opening 80 to admit pipe 71 and exit opening 78 through which the cheese pieces drop onto conveyor 76.

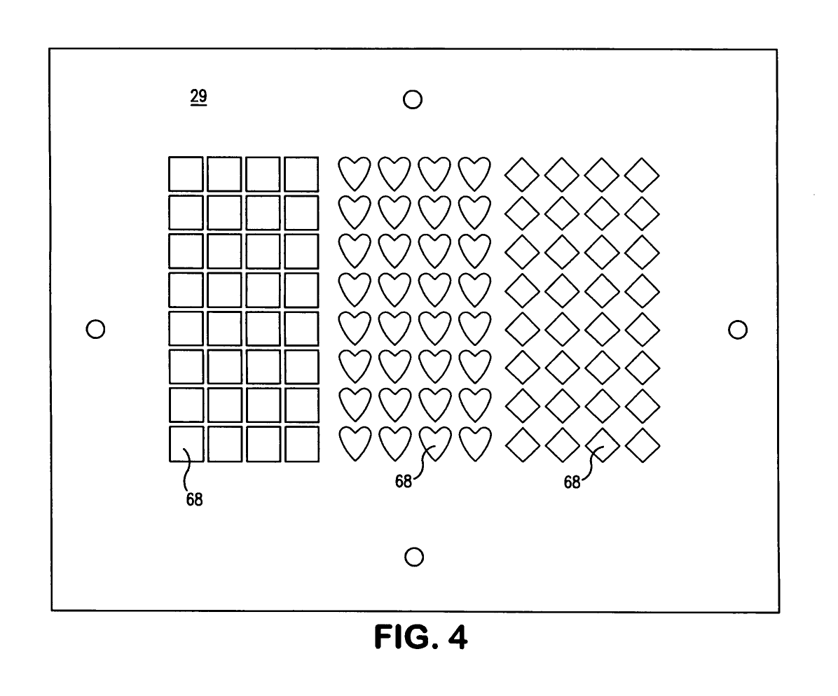

FIG. 4 illustrates other die opening arrangements, illustrated as arrays of diamond-shaped apertures and heart-shaped aperture. Other shapes can be oblong, half round, quarter round, star shape, any isometric shape, a variety of symmetrical and asymmetrical shapes. FIG. 4 simply illustrates that a wide variety of aperture shapes are contemplated as being acceptable. And while multiple aperture shapes can be used in a given die as in FIG. 4, typically any given die will have only a single aperture shape.

If a particular shape of product has been produced and a different shape is desired, the die then-mounted on the receptacle flange can be removed by releasing bolts 30 and replacing that die with another, different die having the openings required to produce the desired product shape.

Receptacle 12 can have any desired cross-section to accommodate the shapes of the blocks of cheese which are contemplated to be pressed through the respective receptacle. Thus the receptacle can have e.g. a round cross-section, or a half-round cross-section, if the blocks of cheese to be so processed have those particular cross-sections.

FIG. 5 shows a representative side elevation view of some of the working elements of the apparatus of the invention. Ram 37 is seen extending from cylinder 36, with pusher plate 38 inside receptacle 12, retracted toward the feed end 21 of the receptacle. A cheese block 35 is shown fed into the receptacle at feed opening 34. Such block of cheese is shown in dashed outline in the exit portion of the receptacle where it would be at the beginning of the process of extruding that block through die 29 in forming the emerging strands of cheese from which the pieces of cheese are cut. Such cut pieces are illustrated in FIG. 5 as elements 82, falling away from the die exit side, past breaker bars 52 and through exit opening 80. The powder entering the enclosure through pipe 71 is illustrated as dots 84 inside the enclosure.

In order for the process of the invention to work as intended, the cheese must be kept cold enough during operation of the process that the cheese is not deformed as the emerging strands are cut by wires 54. The cheese must be kept warm enough that the cheese is not a solid which cannot be extruded with a reasonable amount of pressure. Thus the cheese must not be a frozen solid block. Also, the cheese must be kept cool enough that cross-sections of the emerging strands are not substantially permanently deformed by the actions of the cutting wires. Numerically speaking, a desirable temperature range for the process of the invention is typically about 35 degrees F. to about 65 degrees F.

However, functionally speaking, depending on the specific type of cheese being processed, some cheeses may be processable at cooler temperatures than the recited range, and some cheeses may be processable at temperatures warmer than the recited range. Again, the critical feature is that the cheese must be susceptible to being re-formed in the die, extruded through the die, without exertion of pressures substantially greater than the pressures which can be used within the recited temperature range; and the cheese must be susceptible of being cut by cutting wires 54 without substantial deformation of the cross-section of the emergent strand. So long as these two conditions are met, any temperature is satisfactory. However, it is anticipated that most cheeses will be best processed within the above recited temperature range. A highly desirable temperature of the cheese, for the processing recited herein, is about 50 degrees F. to about 55 degrees F.

In determining the temperature of the cheese for purposes of the invention, numeric temperature is sampled at locations at least 0.25 inch inwardly from the surface of a block or other mass of cheese which is fed into the process, whereby surface gradients in the temperature of the cheese block being fed to the process can sometimes be ignored. The ultimate determination of whether the cheese is operating within the scope of the invention is whether the emergent cheese strands can be cut without substantial deformation of the pieces being cut. As a basis for comparison of deformation, one can use 2-year old cheddar, processed at 50 degrees F., according to the invention, as a standard against which other cheeses can be compared. Thus, minor levels of deformation are inherent in the process. However, most cheeses suitable for processing using the invention can be cut while maintaining substantially the shapes defined by the aperture cross-sections.

The cheese temperature can be controlled in a number of ways. However the temperature of the cheese is controlled, an inherent assumption is that the cheese is introduced to the process of the invention where the temperature of the cheese is already within the desired temperature range and wherein the objective is to maintain the temperature of the cheese in the desired temperature range.

In a first set of conditions the ambient operating environment can be maintained at a desired temperature also within the desired temperature range of the cheese whereby the temperature of the operating environment, including ambient air temperature, cannot cause the temperature of the cheese to be outside its desired temperature range.

In a second set of conditions, the operating, e.g. ambient, environment can be outside the desired temperature range for the cheese but the receptacle and die can be maintained at such temperatures that the temperature influences of the receptacle and die maintain the cheese within the desired temperature range.

In a third set of conditions, the temperatures of the operating ambient environment, of the receptacle, and of the die can all be maintained outside the desired temperature range of the cheese, but the time during which the cheese is exposed to such temperature anomalies can be kept short enough that the cheese can still be cut by wires 54 without detrimental effect on the shapes of the cheese pieces being cut.

If the cheese being fed to the process is not already within the desired temperature range, the various machine elements which contact the cheese are temperature-controlled so as to assist the cheese in achieving an appropriate temperature during the cheese fabricating process of the invention.

The cyclical process of the invention operates as follows.

Starting with the hydraulic ram withdrawn, a block of cheese, substantially conforming to the cross-section of the receptacle, is placed in the receptacle at opening 34.

The ram is advanced, pushing the cheese toward and through die 29. As the cheese strands emerge from the die, the cut-off wheel rotates, and anti-caking material is fed into the shielded area of wheel 40.

The cheese exiting the die is coated with the coating material in the shielded area, and is cut off by wires 54.

The so cut-off individual pieces of cheese drop through the enclosure. The pieces fall against each other, against enclosure shield 45, against disc 48, against ring 50, against breaker bars 53, optionally against cutting wires 54, and ultimately onto take-away conveyor 76.

When the ram reaches the exit end of the receptacle, namely as it approaches the feed side of the die, substantially the entirety of cheese block 35 has been processed through die 29, whereby the ram reverses direction and withdraws to the rear of the receptacle, completing the process cycle and ready to repeat the process cycle again.

Another block of cheese can then be put into the receptacle through feed opening 34. Any scraps of cheese left over from a previous cycle can be placed back in the receptacle and run through the press again.

The force inside the receptacle, namely the back-pressure exerted by die 29, is sufficiently great to knit the pieces together to form unitary pieces of cheese in the emergent strands exiting the die.

A particular novel feature of using a die block, namely die 29 made from a single piece of material, e.g. steel plate, is that the die openings can readily be formed in other than straight lines, whereby apertures 68 can be formed in any of a substantially unlimited variety of curvilinear shapes, such as the heart shapes illustrated in FIG. 4, as well as the straight sides illustrated in FIG. 3, and combinations of straight and curved sides in the same aperture.

The emergent cheese strands are described herein as generally retaining the fabrication conformation of the respective cheese elements of those cheese strands. As used herein, the phrase “generally retains the fabrication conformation” means that modifications of the semi-solid cheese/food product block, which is being fed to the die, are limited to localized shape changes which are required to pass the cheese/food product through apertures of the die to which those cheese elements are closest as the cheese is fed, from the rear of the receptacle, to the die; and also means that all cheese/product is within e.g. about 0.5 inch of an aperture as it reaches proximity with the die; and also means that the cheese is not subjected to any mechanical mixing apparatus as the cheese is being fed through receptacle 12 from opening 34 to exit end 23.

As illustrated herein, disc 48 and ring 50 are both circular, and breaker bars 52 are mounted to both disc 48 and ring 50. However, the invention can operate satisfactorily where neither the first rotating body 48 nor the second rotating body 50 is circular. Rather, the requirement for the rotating bodies is that they need to be so configured that the rotating bodies support breaker bars 52 and cutting wires 54 sufficiently that the breaker bars and cutting wires can perform the described functions of cutting the emerging strands and providing surfaces against which agglomerated cheese pieces can fall to thereby cause separation of the agglomerated pieces.

Thus, both ends of wires 54 can be mounted, by brackets/extensions and the like from disc 48, and the breaker bars can be mounted only to disc 48, whereby ring 50 is optional. Similarly, ring 50 can be so configured, with centrally-located ring structure, that both ends of wires 54 can be mounted to ring 50, and breaker bars 52 can be mounted to ring 50, whereby disc 48 is optional. Thus, while both disc 48 and ring 50 are shown in the illustrated embodiments, the process of the invention can operate satisfactorily with only disc 48 or only with ring 50.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. Apparatus for converting semi-solid food product into a plurality of relatively smaller size product chunks, said converting apparatus comprising:
(a) a receptacle, having a feed portion associated with a feed end of said receptacle, an exit portion associated with an exit end of said receptacle, a length between the feed end and the exit end, an interior space being disposed between the feed end and the exit end, the interior space having a cross-section defined along the length of said receptacle, and a feed opening in the feed portion whereby food product to be converted can be loaded into the interior space of said receptacle;
(b) a forming die connected to the exit end of said receptacle, said forming die having a feed side facing toward said receptacle and an exit side facing away from said receptacle, said forming die comprising a two-dimensional matrix of apertures extending through said forming die between the feed side and the exit side, the two-dimensional matrix of apertures in said forming die extending across substantially the entirety of the cross-section of the interior space defined at the exit end of the receptacle, each aperture in the two-dimensional matrix being spaced from another of the apertures in the matrix by no more than 0.3 inch;
(c) a pusher adapted to engage a mass of semi-solid food product, with such pusher being disposed between the feed end of said receptacle and any such mass of semi-solid food product, and adapted to engage a rear of such mass, and to push such mass in a direction along the length of said receptacle and through said forming die,
said receptacle and said forming die being so cooperatively configured and aligned relative to each other that, when a such mass of semi-solid food product is introduced into the receptacle and pushed through said die by engaging said pusher against the rear of such mass and pushing, thus converting the mass of semi-solid food product into a plurality of emerging strands of such semi-solid food product, such emerging strands having strand lengths, and cross-sections substantially smaller than the cross-section of the exit portion of said receptacle, substantial portions of the semi-solid food product emerge from said die having maintained longitudinal alignment with the respective apertures before, during, and after passing through the respective apertures, relative to where those portions were when received in the receptacle; and
(d) a cutter which periodically cuts such emerging strands transverse to the lengths of such strands, thereby to convert such emerging strands into multiple individual and separate pieces of such food product.

2. Apparatus as in claim 1,
said pusher being adapted to engage such mass of food product, as a semi-solid feed block, only at a trailing end of such feed block, wherein such feed block has a fabrication conformation and can generally hold cross-section stability of such fabrication conformation while being pushed through said die, and said receptacle and said forming die being so cooperatively configured and aligned relative to each other that, when a such feed block of semi-solid food product, having a cross-section generally conforming to the cross-section of the exit portion of said receptacle, is placed in said receptacle and forced through said die by engaging said pusher against the trailing end of such feed block and pushing, thus converting such feed block of semi-solid food product into such plurality of emerging strands of semi-solid food product, the semi-solid food product strands emerging from the die generally retain the fabrication conformation of such feed block.

3. Apparatus as in claim 1, further comprising a separator which separates newly-agglomerated ones of such pieces from each other.

4. Apparatus as in claim 3, said separator and said cutter collectively comprising
(i) a wheel having an outer perimeter edge and a plurality of cutting wires extending across said wheel transverse to the outer perimeter edge,
(ii) an enclosure substantially enclosing a space extending lengthwise away from the exit side of said die and enclosing said wheel,
(iii) a powder dispenser adapted to feed powder into such enclosed space,
(iv) an exit opening at a bottom of said enclosure, sized and configured to accommodate the emergent and cut pieces of product exiting the enclosure, and
(v) breaker bars on said wheel, said breaker bars rotating with said wheel, such that said breaker bars pass across the exit opening as said wheel rotates,
whereby as said wheel rotates and said cutting wires engage the emerging strands, and cut pieces of product from such emerging strands, such pieces of product are coated by powder dispensed from said powder dispenser, and such coated pieces of product fall toward the exit opening, and are engaged by said breaker bars passing across the exit opening, such engagement between said moving breaker bars and such pieces of product tending to separate pieces of such product which have agglomerated with each other.

5. Apparatus as in claim 1 wherein walls of the apertures extend between the feed side and the exit side at angles of no more than 10 degrees relative to the direction in which such mass of food product is pushed through said die.

6. Apparatus as in claim 1 wherein walls of the apertures extend from the feed side to the exit side in a generally common direction.

7. Apparatus as in claim 6, said die having a thickness, between the feed side and the exit side, of at least about 0.25 inch.

8. Apparatus as in claim 1, walls of the apertures, which face inwardly into the aperture openings, having surface finishes which, when semi-soft cheese product is pushed through said die, tend to create smooth surfaces on the cheese product strands which emerge from such apertures at the exit side of said die, and wherein thickness of said die between the feed side and the exit side is great enough that said die forces elongation of such emerging cheese strands such that such smooth surfaces created by the walls of the apertures are generally retained in the emergent cheese strands, and adjacent ones of the emergent strands of cheese remain spaced from each other upon exiting said die.

9. Apparatus as in claim 1, each aperture being spaced from each of the other apertures, at locus of closest proximity, by at least 0.03 inch, and spaced from adjacent ones of the other apertures, at locus of closest proximity, by no more than 0.2 inch.

10. Apparatus as in claim 1, said pusher having a pushing surface which extends across substantially the entire cross-section of the interior space of said receptacle between the feed opening and the exit end of said receptacle.

11. Apparatus for converting semi-solid food product into a plurality of relatively smaller size product chunks, said converting apparatus comprising:
(a) a receptacle, having a feed portion associated with a feed end of said receptacle, an exit portion associated with an exit end of said receptacle, a length between the feed end and the exit end, an interior space between the feed end and the exit end, the interior space having a cross-section defined along the length of said receptacle, and a feed opening in the feed portion whereby food product to be converted can be loaded into the interior space of said receptacle;
(b) a forming die connected to the exit end of said receptacle, said forming die having a feed side facing toward said receptacle and an exit side facing away from said receptacle, said forming die comprising a two-dimensional matrix of apertures extending through said forming die between the feed side and the exit side;
(c) a pusher adapted to engage a mass of semi-solid food product, with such pusher being disposed between the feed end of said receptacle and any such mass of semi-solid food product, and adapted to engage a rear of such mass, and to push such mass along the length of said receptacle and through said forming die; and
(d) a cutter, said cutter comprising a wheel having an outer perimeter edge, and a plurality of cutting wires extending across said wheel transverse to the outer perimeter edge, said wheel being mounted on a shaft for rotation, with said shaft as the axis of such rotation, said shaft extending in a direction generally aligned with the length of said receptacle, and off-set transversely from said receptacle, said wheel being aligned with, and positioned relative to, said forming die such that rotation of said wheel causes said cutting wires to pass across the exit side of said forming die, in close proximity to said forming die such that said cutting wires cut such emerging strands, emerging from said forming die, substantially at the exit side of said forming die, cutting such emerging strands transverse to lengths of such emerging strands, thereby to convert such emerging strands into multiple individual and separate pieces of such food product.

12. Apparatus as in claim 11,
said pusher being adapted to engage such mass of food product, as a semi-solid feed block, only at a trailing end of such feed block, wherein such feed block has a fabrication conformation and can generally hold cross-section stability of such fabrication conformation while being pushed through said die, and said receptacle and said forming die being so cooperatively configured and aligned relative to each other that, when a such feed block of semi-solid food product, having a cross-section generally conforming to the cross-section of the exit portion of said receptacle, is placed in the receptacle and forced through said die by engaging said pusher against the trailing end of such feed block and pushing, thus converting such feed block of semi-solid food product into such plurality of emerging strands of such semi-solid food product, the semi-solid food product strands emerging from the die generally retain the fabrication conformation of such feed block.

13. Apparatus as in claim 11, further comprising a separator which separates newly-agglomerated ones of such pieces from each other.

14. Apparatus as in claim 13, said separator and said cutter collectively comprising
(i) said wheel,
(ii) an enclosure substantially enclosing a space extending lengthwise away from the exit side of said die and enclosing said wheel,
(iii) a powder dispenser adapted to feed powder into such enclosed space,
(iv) an exit opening at a bottom of said enclosure, sized and configured to accommodate the emergent and cut pieces of product exiting the enclosure, and
(v) breaker bars on said wheel, said breaker bars rotating with said wheel, such that said breaker bars pass across the exit opening as said wheel rotates,
whereby as said wheel rotates and said cutting wires engage the emerging strands, and cut pieces of product from such emerging strands, such pieces of product are coated by powder dispensed from said powder dispenser, and such coated pieces of product fall toward the exit opening, and are engaged by said breaker bars passing across the exit opening, such engagement between said moving breaker bars and such pieces of product tending to separate pieces of such product which have agglomerated with each other.

15. Apparatus as in claim 11, said wheel comprising a first rotating body, and a second rotating body spaced from said first rotating body, and positioned toward said receptacle relative to said first rotating body, said breaker bars extending between said first and second rotating bodies.

16. Apparatus as in claim 15 wherein said first rotating body extends from a first outer perimeter to a central axis of rotation of said first rotating body, at least portions of said first rotating body being projectable onto said second rotating body, and wherein said breaker bars are mounted to both of said first and second rotating bodies, and extend across the space between said first and second rotating bodies.

17. Apparatus as in claim 11, said pusher having a pushing surface which extends across substantially the entire cross-section of the interior space in said receptacle, between the feed opening and the exit end of said receptacle.

18. A method of making cheese chunks, individual and separated from each other, the method comprising:
(a) introducing a mass of cheese through a feed opening into an interior space in a receptacle having a feed portion associated with a feed end of the receptacle, and an exit portion associated with an exit end of the receptacle, the interior space being disposed between the feed end and the exit end and having a cross-section defined along the length of the receptacle, the feed opening providing product feed access to the interior space;
(b) engaging a pusher against the mass of cheese, with the pusher being disposed between the feed end of the receptacle and the mass of cheese, and pushing the mass of cheese in a direction along the length of the receptacle and through a forming die and thereby concurrently forming a plurality of cheese strands emerging from the forming die, the forming die comprising a two-dimensional matrix of apertures extending through the forming die, the two-dimensional matrix of apertures in the forming die extending across substantially an entirety of a cross-section of the interior space, defined at the exit end of the receptacle,
such that substantial portions of the semi-solid cheese strands emerging from the forming die generally have maintained longitudinal alignment with the respective apertures before, during, and after passing through the respective apertures, relative to where those portions were when received in the receptacle;
(c) periodically cutting the emerging cheese strands transverse to the lengths of such strands, thereby to convert such emerging strands into multiple individual and separate pieces of such cheese; and
(d) allowing the cut pieces to fall away from the forming die.

19. A method as in claim 18 wherein the loading of the mass of cheese comprises loading a single block of cheese into the receptacle and wherein a cross-section of the single block of cheese corresponds, with only processing clearance, with the cross-section of the interior space in the exit portion of the receptacle.

20. A method as in claim 18, further comprising allowing the cut cheese pieces to fall away from the die along a generally-defined path, coating the cut cheese pieces with anti-caking powder, and interrupting the fall of the pieces by engaging the cut pieces with breaker bars, in the known path, thereby to separate ones of such cheese pieces which have agglomerated with each other.

21. A method as in claim 18 wherein the pusher has a pushing surface which extends across substantially the entire cross-section of the interior space in the exit portion of the receptacle.

22. A method as in claim 18 wherein the emerging strands emerging from the die apertures have cross-sections of at least 0.06 square inch.

23. A method as in claim 18 wherein the emerging strands emerging from the die apertures have cross-sections of at least 0.14 square inch.
